(19) United States
(12) Patent Application Publication
(10) Pub. No.: US 2024/0164984 A1
(43) Pub. Date: May 23, 2024

(54) INSULATED SAUNA TENT FOR THERAPEUTIC USE

(71) Applicant: SWEATTENTS LLC, CHEYENNE, WY (US)

(72) Inventor: Travis E. Price, Palos Verdes Estates, CA (US)

(21) Appl. No.: 18/426,183

(22) Filed: Jan. 29, 2024

Related U.S. Application Data
(63) Continuation-in-part of application No. 29/856,266, filed on Oct. 12, 2022.
Application No. 29/856,266 is a continuation-in-part of application No. 29/861,551, filed on Nov. 30, 2022.
Application No. 29/861,551 is a continuation-in-part of application No. 29/881,553, filed on Jan. 3, 2023.
Application No. 29/881,553 is a continuation-in-part of application No. 29/881,978, filed on Jan. 9, 2023.
Application No. 29/881,978 is a continuation-in-part of application No. 29/894,613, filed on Jun. 12, 2023.
Application No. 29/894,613 is a continuation-in-part of application No. 29/896,320, filed on Jun. 30, 2023.
Application No. 29/896,320 is a continuation-in-part of application No. 29/898,933, filed on Aug. 2, 2023.
Application No. 29/898,933 is a continuation-in-part of application No. 29/922,377, filed on Dec. 21, 2023.

(51) Int. Cl. A61H 33/06; E04H 15/16; E04H 15/44; E04H 15/54; E04H 15/58; E04H 15/24

(52) U.S. Cl. CPC A61H 33/065; E04H 15/16; E04H 15/44; E04H 15/54; E04H 15/58; A61H 2201/0228; E04H 15/24

(57) ABSTRACT

One embodiment provides a portable and insulated sauna tent comprising a collapsible tent frame including a plurality of connectable framing rods. The sauna tent further comprises a continuous fabric awning that is multi-layered, weatherproof, and insulated. The fabric awning is attached to and covers an entirety of the tent frame. The tent frame and the fabric awning together form an insulated enclosure with a plurality of tent sidewalls and a roof top when the tent frame is assembled into an upright position by connecting the framing rods. The insulated enclosure reaches and maintains a temperature suitable for therapeutic use when a portable sauna stove is placed inside the insulated enclosure and heated up.

### CROSS REFERENCE TO RELATED APPLICATIONS

This application is a continuation-in-part of U.S. Non-Provisional Design Patent Application No. 29/856,266, filed on Oct. 12, 2022, U.S. Non-Provisional Design Patent Application No. 29/861,551, filed on Nov. 30, 2022, U.S. Non-Provisional Design Patent Application No. 29/881,553, filed on Jan. 3, 2023, U.S. Non-Provisional Design Patent Application No. 29/881,978, filed on Jan. 9, 2023, U.S. Non-Provisional Design Patent Application No. 29/894,613, filed on Jun. 12, 2023, U.S. Non-Provisional Design Patent Application No. 29/896,320, filed on Jun. 30, 2023, U.S. Non-Provisional Design Patent Application No. 29/898,933, filed on Aug. 2, 2023, and U.S. Non-Provisional Design Patent Application Number 29/922,377, filed on Dec. 21, 2023, all incorporated herein by reference.

### TECHNICAL FIELD

One or more embodiments relate generally to saunas, and in particular, an insulated sauna tent for therapeutic use.

### BACKGROUND

A sauna is a room, building, or enclosure designed as a place to experience dry or wet heat sessions.

### SUMMARY

One embodiment provides a portable and insulated sauna tent comprising a collapsible tent frame including a plurality of connectable framing rods. The sauna tent further comprises a continuous fabric awning that is multi-layered, weatherproof, and insulated. The fabric awning is attached to and covers an entirety of the tent frame. The tent frame and the fabric awning together form an insulated enclosure with a plurality of tent sidewalls and a roof top when the tent frame is assembled into an upright position by connecting the framing rods. The insulated enclosure reaches and maintains a temperature suitable for therapeutic use when a portable sauna stove is placed inside the insulated enclosure and heated up.

Another embodiment provides a portable and insulated sauna system comprising a collapsible tent frame including a plurality of connectable framing rods. The system further comprises a continuous fabric awning that is multi-layered, weatherproof, and insulated. The fabric awning is attached to and covers an entirety of the tent frame. The tent frame and the fabric awning together form an insulated enclosure with a plurality of tent sidewalls and a roof top when the tent frame is assembled into an upright position by connecting the framing rods. The system further comprises a portable sauna stove. The insulated enclosure reaches and maintains a temperature suitable for therapeutic use when the portable sauna stove is placed inside the insulated enclosure and heated up.

These and other features, aspects and advantages of the one or more embodiments will become understood with reference to the following description, appended claims and accompanying figures.

### BRIEF DESCRIPTION OF THE DRAWINGS

FIG. 1A illustrates a front perspective view of an insulated sauna tent, in one or more embodiments;

FIG. 1B illustrates a front view of the insulated sauna tent in FIG. 1A, in one or more embodiments;

FIG. 1C illustrates a left side view of the insulated sauna tent in FIG. 1A, in one or more embodiments;

FIG. 1D illustrates a rear view of the insulated sauna tent in FIG. 1A, in one or more embodiments;

FIG. 1E illustrates a right side view of the insulated sauna tent in FIG. 1A, in one or more embodiments;

FIG. 1F illustrates a top view of the insulated sauna tent in FIG. 1A, in one or more embodiments;

FIG. 2A illustrates a front perspective view of a sauna stove, in one or more embodiments;

FIG. 2B illustrates a front view of the sauna stove in FIG. 2A, in one or more embodiments;

FIG. 2C illustrates a left side view of the sauna stove in FIG. 2A, in one or more embodiments;

FIG. 2D illustrates a rear view of the sauna stove in FIG. 2A, in one or more embodiments;

FIG. 2E illustrates a right side view of the sauna stove in FIG. 2A, in one or more embodiments;

FIG. 2F illustrates a top view of the sauna stove in FIG. 2A, in one or more embodiments;

FIG. 2G illustrates a front perspective close-up view of the sauna stove in FIG. 2A, in one or more embodiments;

FIG. 3 illustrates a sequence of user steps required to assemble the sauna tent and install the sauna stove inside the sauna tent, in one or more embodiments;

FIG. 4 illustrates an insulated enclosure created inside the sauna tent, in one or more embodiments;

FIG. 5 illustrates a sequence of user steps required to fire up the sauna stove when inside the sauna tent, in one or more embodiments;

FIG. 6A illustrates a perspective view of another insulated sauna tent, in one or more embodiments;

FIG. 6B illustrates a front view of the insulated sauna tent in FIG. 6A, in one or more embodiments;

FIG. 6C illustrates a rear view of the insulated sauna tent in FIG. 6A, in one or more embodiments;

FIG. 6D illustrates a right side view of the insulated sauna tent in FIG. 6A, in one or more embodiments;

FIG. 6E illustrates a left side view of the insulated sauna tent in FIG. 6A, in one or more embodiments;

FIG. 6F illustrates a top view of the insulated sauna tent in FIG. 6A, in one or more embodiments;

FIG. 7A illustrates a perspective view of the insulated sauna tent in FIG. 1A with another roof top cover secured to the roof top of the sauna tent, in one or more embodiments;

FIG. 7B illustrates a close-up view of the roof top cover in FIG. 7A secured to the roof top of the sauna tent, in one or more embodiments;

FIG. 7C illustrates the roof top cover in FIG. 7A on its own, in one or more embodiments;

FIG. 8A illustrates a perspective view of the insulated sauna tent in FIG. 6A with yet another roof top cover secured to the roof top of the sauna tent, in one or more embodiments; and

FIG. 8B illustrates another perspective view of the insulated sauna tent in FIG. 6A with the roof top cover in FIG. 8A secured to the roof top of the sauna tent, in one or more embodiments.

### DETAILED DESCRIPTION

The following description is made for the purpose of illustrating the general principles of one or more embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

One or more embodiments relate generally to saunas, and in particular, an insulated sauna tent for therapeutic use. One embodiment provides a portable and insulated sauna tent comprising a collapsible tent frame including a plurality of connectable framing rods. The sauna tent further comprises a continuous fabric awning that is multi-layered, weatherproof, and insulated. The fabric awning is attached to and covers an entirety of the tent frame. The tent frame and the fabric awning together form an insulated enclosure with a plurality of tent sidewalls and a roof top when the tent frame is assembled into an upright position by connecting the framing rods. The insulated enclosure reaches and maintains a temperature suitable for therapeutic use when a portable sauna stove is placed inside the insulated enclosure and heated up.

Another embodiment provides a portable and insulated sauna system comprising a collapsible tent frame including a plurality of connectable framing rods. The system further comprises a continuous fabric awning that is multi-layered, weatherproof, and insulated. The fabric awning is attached to and covers an entirety of the tent frame. The tent frame and the fabric awning together form an insulated enclosure with a plurality of tent sidewalls and a roof top when the tent frame is assembled into an upright position by connecting the framing rods. The system further comprises a portable sauna stove. The insulated enclosure reaches and maintains a temperature suitable for therapeutic use when the portable sauna stove is placed inside the insulated enclosure and heated up.

Traditional saunas, like wood-fired or electric Finnish-style barrel saunas, offer health benefits as these are able to reach temperatures suitable for therapeutic use, i.e., ranging from about 176° F. to about 212° F. When the human body is exposed to these temperatures frequently (e.g., 3-4 times per week for 10-20 minutes per session), it has been proven to reduce the risk of all-cause mortality. However, traditional saunas are constructed out of wood or wood alternatives, thereby making these saunas cost-prohibitive to the average consumer. Other conventional solutions, such as portable steam or infrared sauna tents and sauna blankets, are incapable of reaching temperatures suitable for therapeutic use.

One or more embodiments provide a portable and insulated sauna tent for therapeutic use that is both cost-effective and designed to reach a maximum temperature of 220° F.

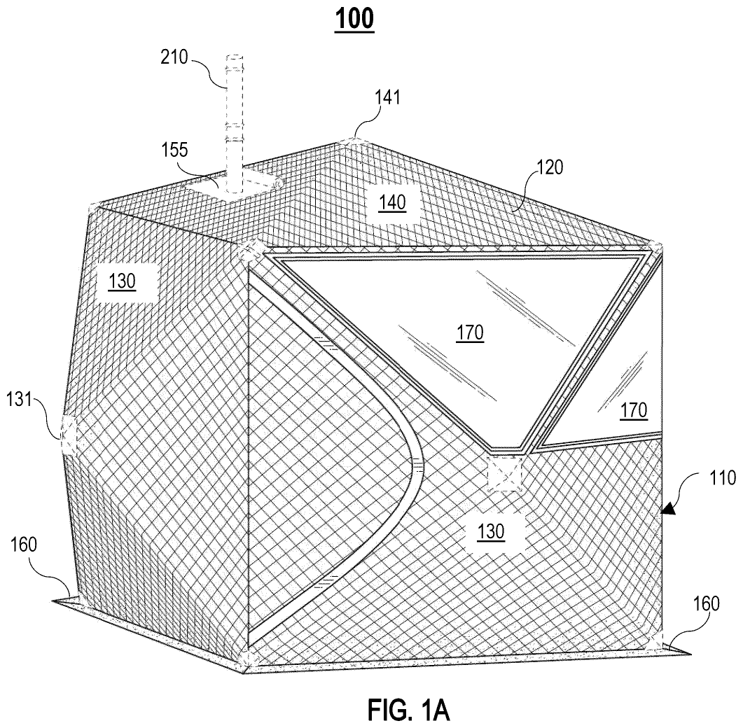

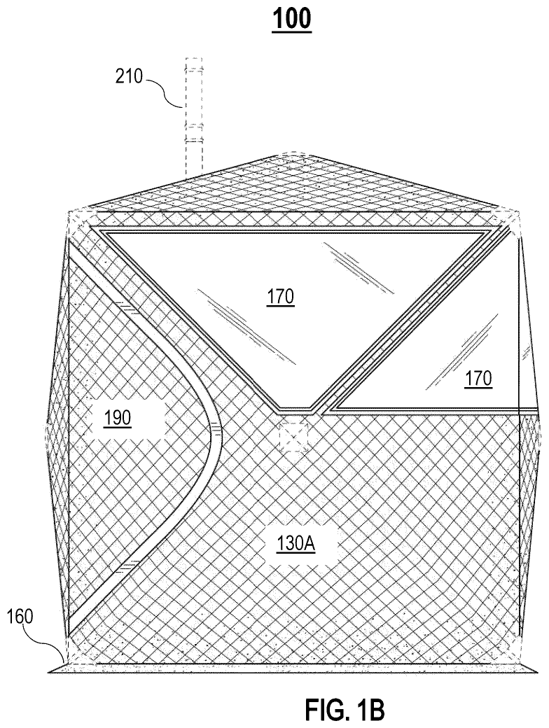

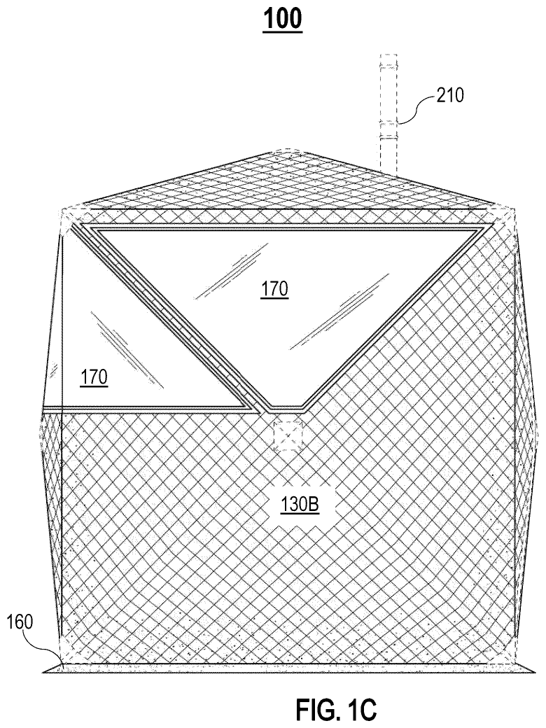

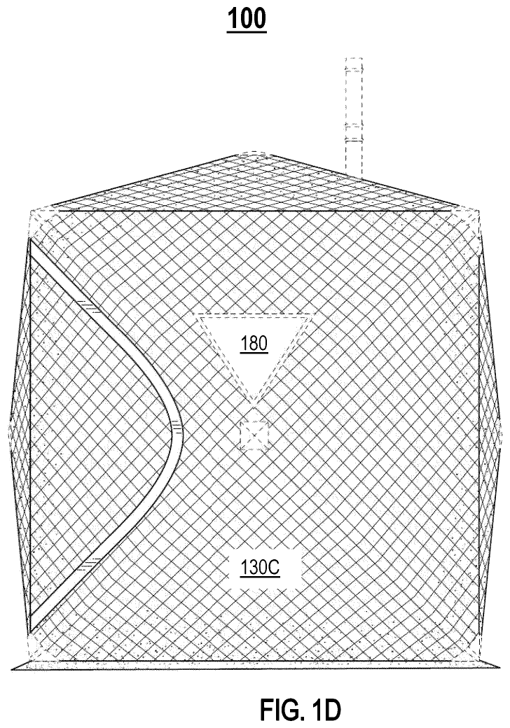

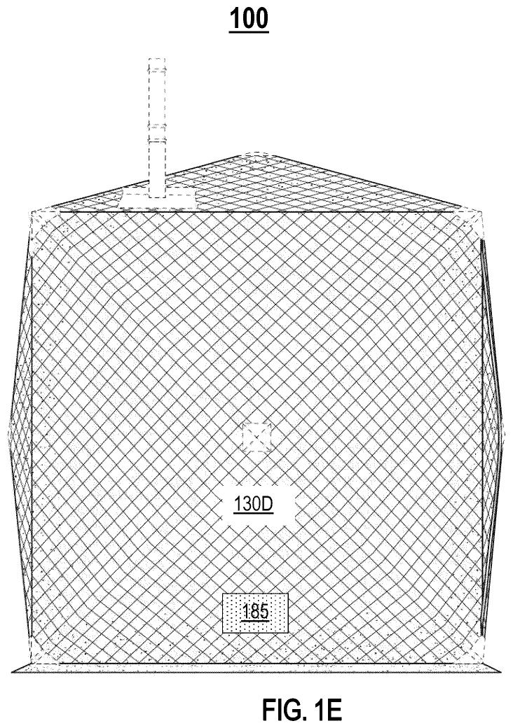

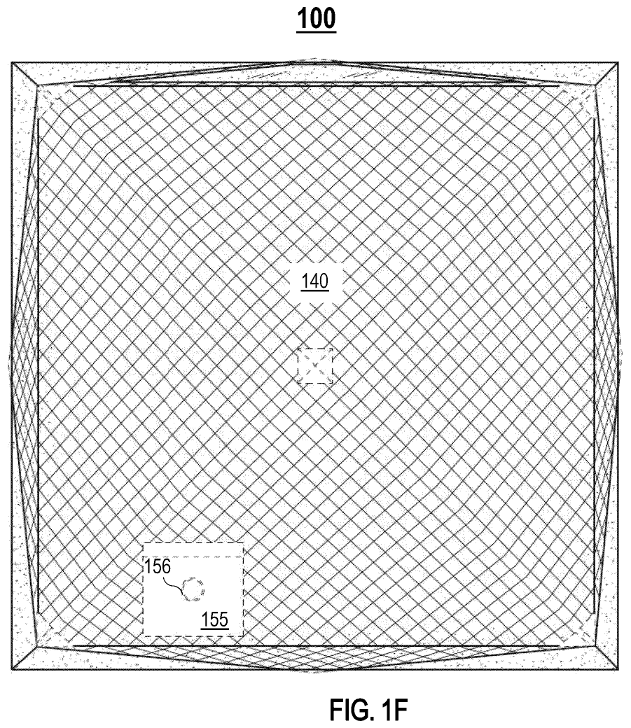

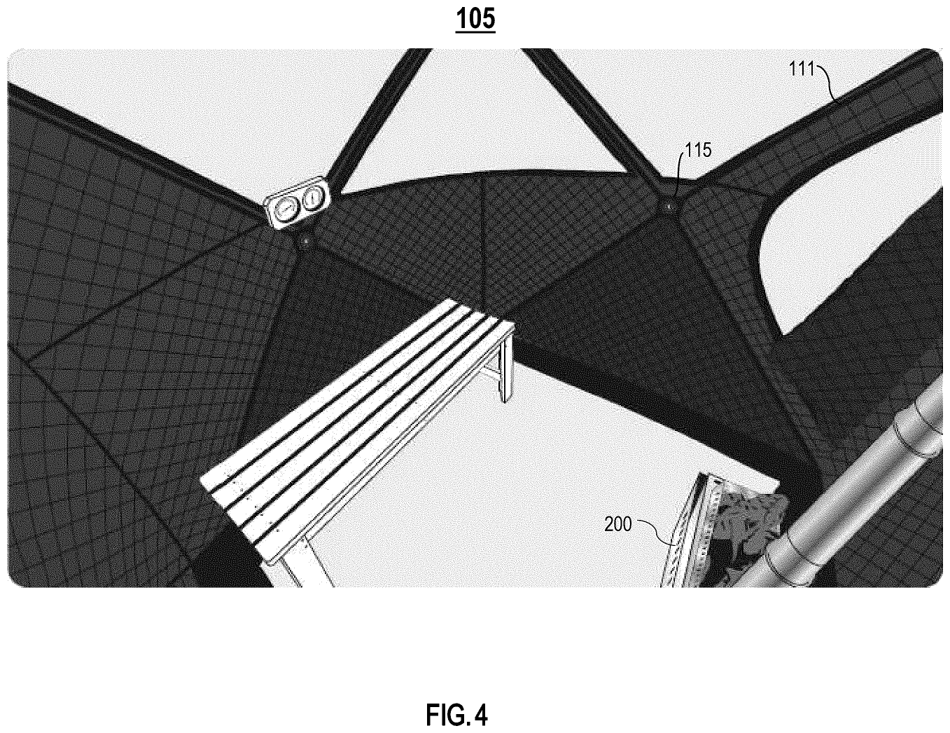

FIG. 1A illustrates a front perspective view of an insulated sauna tent 100, in one or more embodiments. The sauna tent 100 comprises a collapsible tent frame 110 including a plurality of framing rods 111 (FIG. 4). In one embodiment, the framing rods 111 are composed of any type of metal alloy or polymer such as, but not limited to, aluminum, steel, fiberglass, carbon fiber, etc. In another embodiment, the framing rods 111 are composed of another type of material such as, but not limited to, wood.

In one embodiment, the tent frame 110 (and in turn the sauna tent 100) is assembled to stand in an upright position by fitting/locking together the framing rods 111 into place using attachment mechanisms 115 (FIG. 4) such as, but not limited to, spoke center hubs, snapfit connectors (e.g., a cantilever snap, an annular snap, a trap, a dart, etc.), push-pull connectors, carabiners and straps, etc. The sauna tent 100 is assembled in a pop-up fashion. The tent frame 110 (and in turn the sauna tent 100) is disassembled and collapsed by disconnecting/unlocking and collapsing the framing rods 111.

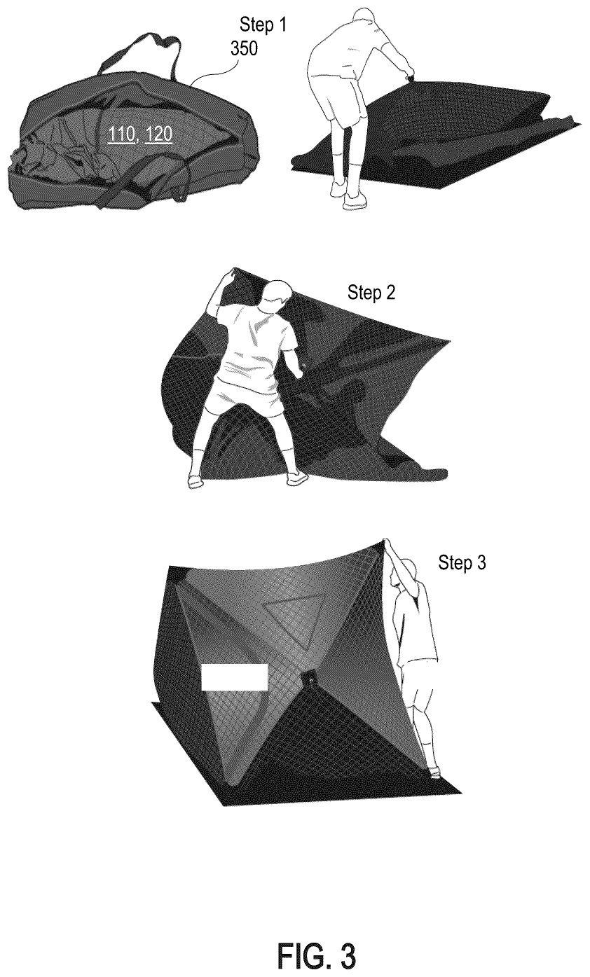

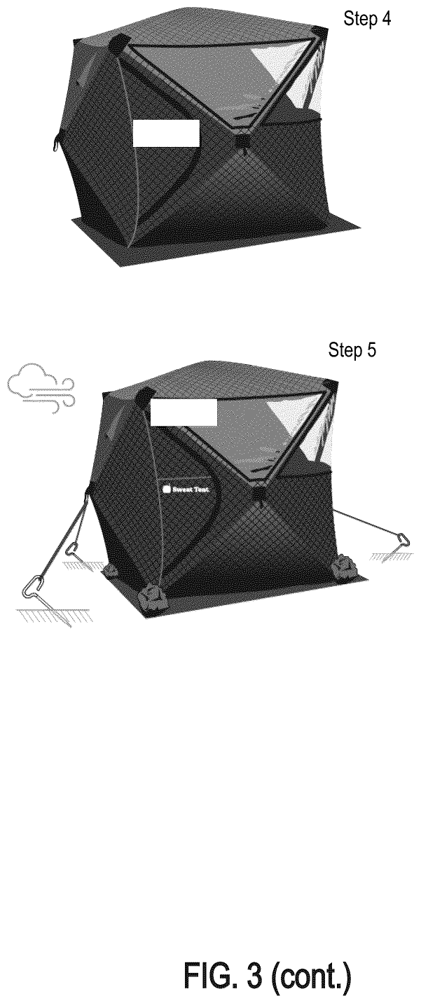

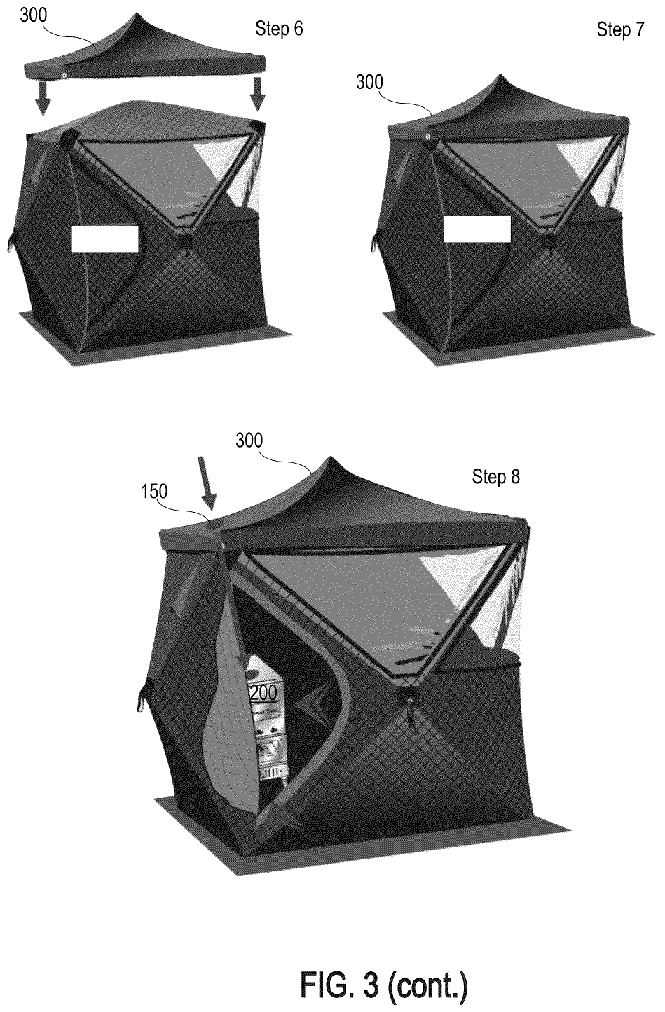

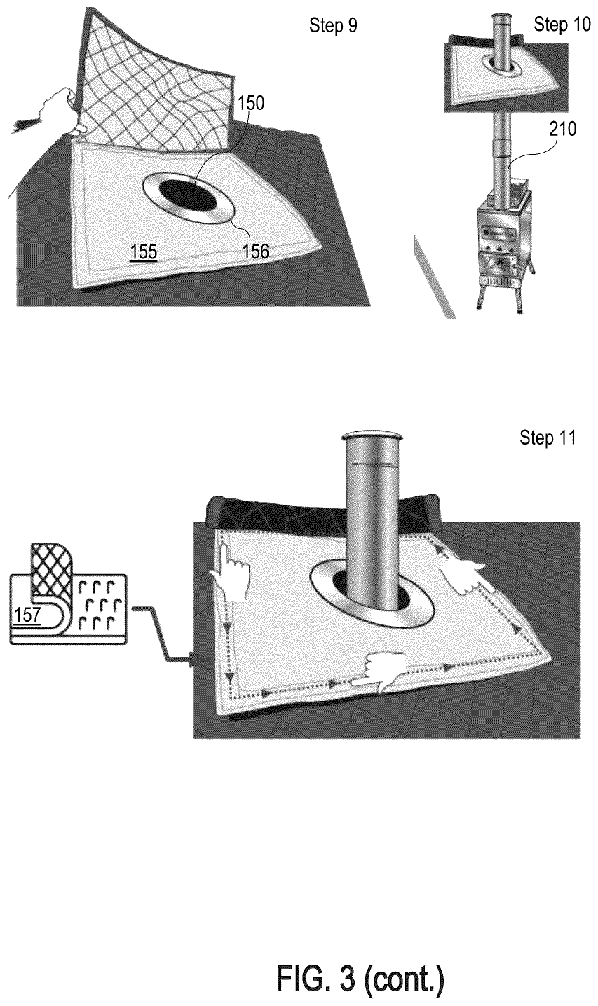

The sauna tent 100 comprises a continuous fabric awning 120 attached to the tent frame 110. In one embodiment, the disassembled and collapsed tent frame 110 including the fabric awning 120 are transportable in a carry bag 350 (FIG. 3).

In one embodiment, the fabric awning 120 is multi-layered (i.e., two layers or more), weatherproof, and insulated. For example, in one embodiment, the fabric awning 120 comprises a durable triple-layered quilted fabric consisting of a first layer of water-resistant/weather-resistant fabric, a second layer of synthetic heating/insulation material, and a third layer of water-resistant/weather-resistant fabric. The first layer of water-resistant/weather-resistant fabric and the third layer of water-resistant/weather-resistant fabric form the outermost layer and innermost layer of the fabric awning 120, respectively. The second layer of synthetic heating/insulation material is positioned in-between both layers of water-resistant/weather-resistant fabric. In one embodiment, both layers of water-resistant fabric are composed of polyester or nylon (e.g., Oxford or Taffeta fabrics, such as Oxford 210D nylon) with a polyurethane coating applied to repel moisture. In one embodiment, the layer of synthetic heating/insulation material is composed of any material suitable for heating/insulation and of any density.

In one embodiment, the fabric awning 120 is thermal-sealed (i.e., the fabric stitching of the fabric awning 120 comprises thermal seams), such that no holes are created in the fabric awning 120, thereby preventing cold air, moisture, and other elements of the environment from entering the sauna tent 100. In another embodiment, the fabric stitching of the fabric awning 120 comprises traditional sewing seams.

The tent frame 110 and the fabric awning 120 are designed/shaped to provide a plurality of tent sidewalls (i.e., tent side panels) 130 and a roof top 140 that together create an insulated enclosure 105 (FIG. 3) inside the sauna tent 100. For example, as shown in FIGS. 1A-1E, in one embodiment, the plurality of tent sidewalls 130 include at least four tent sidewalls 130, i.e., a first tent sidewall 130A (FIG. 1B), a second tent sidewall 130B (FIG. 1C), a third tent sidewall 130C (FIG. 1D), and a fourth tent sidewall 130D (FIG. 1E). The roof top 140 and each tent sidewall 130 include one or more endpoints 131 to facilitate assembly of the sauna tent 100. As described in detail later herein, one or more sauna stoves 200 may be positioned inside the sauna tent 100.

In one embodiment, the roof top 140 includes one or more hole openings 150 (FIG. 3), wherein each hole opening 150 corresponds to a sauna stove 200 positioned directly below the hole opening 150 and inside the sauna tent 100. Each hole opening 150 has a corresponding fabric chimney hole cover 155 including a metal-lined opening 156 (e.g., a metal circular ring) (FIG. 1F and FIG. 3) designed/shaped to sit over the hole opening 150 and receive a chimney pipe 210 of a sauna stove 200, thereby allowing the chimney pipe 210 to pass through from inside the sauna tent 100 to outside the sauna tent 100. In one embodiment, the back of each fabric chimney hole cover 155 includes velcro 157 (FIG. 3) or some other attachment mechanism for securing the cover 155 to the top of the sauna tent 100.

In one embodiment, the sauna tent 100 comprises an optional removable roof top cover 300 (FIG. 3) that may be placed on top of the roof top 140 to cover at least the roof top 140 and top edges of the tent sidewalls 130. The roof top cover 130 includes one or more hole openings (not shown) that align with one or more hole openings in the roof top 140. The roof top cover 300 protects the sauna tent 100 from damage by preventing runaway fire sparks emanating from a chimney pipe 210 of a sauna stove 200 inside the sauna tent 100 from burning holes in the roof top 140. The roof top cover 300 also further insulates the sauna tent 100. In one embodiment, the roof top cover 300 is made out of flame-retardant/flame-resistant and waterproof/weatherproof materials such as, but not limited to, fiberglass.

Together, the fabric awning 120, the sauna stove 200, and the roof top cover 300 enhance the insulating properties of the sauna tent 100, enabling the inside of the sauna tent 100 to reach temperatures of about 176° F. to about 212° F. within about thirty (30) minutes of firing/heating up the sauna stove 200, and a maximum temperature of 220° F. The fabric awning 120 allows the temperature inside of the sauna tent 100 to be maintained in any environment. This combination of materials—the tent frame 110, the fabric awning 120, the sauna stove 200, and the roof top cover 300—provide a compact, lightweight, portable, and cost-effective sauna capable of reaching and maintaining a high heat output. Unlike traditional saunas such as Finnish-style saunas, the sauna tent 100 provides a user with an accessible and affordable therapeutic sauna experience.

In one embodiment, the sauna tent 100 has a variety of sizes. For example, a size of the insulated enclosure 105 (FIG. 3) created inside the sauna tent 100 can range from about 64 cubic ft. to about 700 cubic ft.

In one embodiment, the sauna tent 100 has a variety of shapes such as, but not limited to, pyramids, squares, rectangles, hexagons, octagons, etc. For example, as shown in FIGS. 1A-1F, in one embodiment, a shape of the sauna tent 100 comprises any number of polyhedrons (i.e., three-dimensional shapes with flat polygonal faces, straight edges, and sharp corners or vertices).

In one embodiment, the sauna tent 100 does not include any floor/flooring. The sauna tent 100 can be assembled to stand upright on any substantially flat surface, such as the ground, a floor, etc. For example, the sauna tent 100 may be assembled on a suitable, well-ventilated area outside on concrete, tile, dirt, grass, turf, ice, or unvarnished wood surface (e.g., as shown in FIG. 3). In another embodiment, the sauna tent 100 comprises an optional floor/flooring.

In one embodiment, the fabric awning 120 provides a plurality of tent skirts 160 attached to bottom edges of the tent sidewalls 130, such that each tent sidewall 130 has a corresponding exterior/outer tent skirt 160 (i.e., located outside of the sauna tent 100) and a corresponding interior/inner tent skirt 160 (i.e., located inside the sauna tent 100). The tent skirts 160 are designed/shaped to lay flat on top of a surface that the sauna tent 100 is assembled on. Weights (e.g., potted plants, rocks, bricks, cinder blocks, etc.) and/or material (e.g., snow, sand, etc.) may be placed on top of the exterior/outer tent skirts 160 to weigh it down and in turn seal the perimeter of the sauna tent 100 and secure the sauna tent 100 to the surface, thereby preventing the sauna tent 100 from blowing over and further preventing wind and wind-driven elements (e.g., wind-driven sand, wind-driven snow) from entering inside the sauna tent 100.

In one embodiment, a tent sidewall 130 and/or the roof top 140 may include one or more windows 170. In one embodiment, each window 170 is composed of a high-temperature performance material such as, but not limited to, thermoplastic polyurethane (TPU), etc. Each window 170 allows ambient light to enter the sauna tent 100 and/or provides a user inside the sauna tent 100 to view outside the sauna tent 100 (e.g., provide a 180° view). The windows 170 of the sauna tent 100 may have a variety of shapes and sizes.

In one embodiment, a tent sidewall 130 and/or the roof top 140 may include one or more temperature control vents 180 (FIG. 1D) to help circulate air inside the sauna tent 100 and keep the temperature inside of the sauna tent 100 regulated. In one embodiment, a tent sidewall 130 and/or the roof top 140 may include one or more fresh air intake vents 185 (FIG. 1E) for intake of fresh air into the sauna tent 100. Each fresh air intake vent 185 is slidable between a fully open position, a halfway open position, and a fully closed position.

FIG. 1B illustrates a front view of the insulated sauna tent 100, in one or more embodiments. In one embodiment, the first tent sidewall 130A includes one or more windows 170 positioned in a top half of the sidewall 130A. In one embodiment, the first tent sidewall 130A includes a zippable tent flap 190 that operates as a door, providing access/entry into the inside of the sauna tent 100.

In one embodiment, the tent 100 includes multiple zippable tent flaps 190 (e.g., one that operates as a front door at the front of the tent 100, and another that operates as a back door at the back of the tent 100).

FIG. 1C illustrates a left side view of the insulated sauna tent 100, in one or more embodiments. In one embodiment, the second tent sidewall 130B includes one or more windows 170 positioned in a top half of the sidewall 130B.

FIG. 1D illustrates a rear view of the insulated sauna tent 100, in one or more embodiments. In one embodiment, the third tent sidewall 130C includes one or more windows temperature control vents 180 positioned in a top half of the sidewall 130C. Each vent 180 is partially concealed (e.g., by the fabric awning 120).

FIG. 1E illustrates a right side view of the insulated sauna tent 100, in one or more embodiments. In one embodiment, the fourth tent sidewall 130D includes one or more windows fresh air intake vents 185 positioned in a bottom half of the sidewall 130D (i.e., towards a bottom edge of the sidewall 130D).

FIG. 1F illustrates a top view of the insulated sauna tent 100, in one or more embodiments. In one embodiment, the roof top 140 includes a fabric chimney hole cover 155 positioned within proximity of an edge of the roof top 140. The cover 155 includes a metal-lined opening 156 through which a chimney pipe 210 (FIG. 1A) of a corresponding sauna stove 200 inside the sauna tent 100 can pass through.

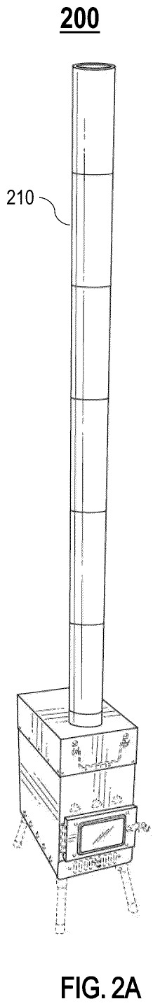

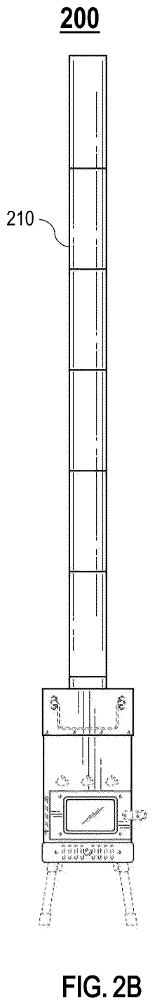

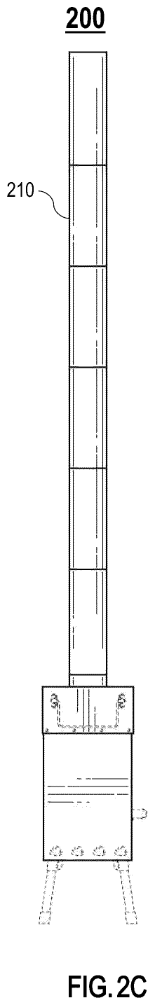

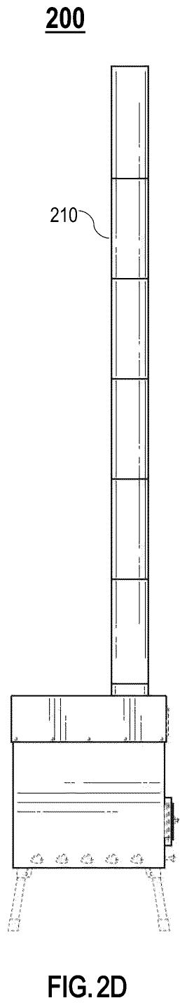

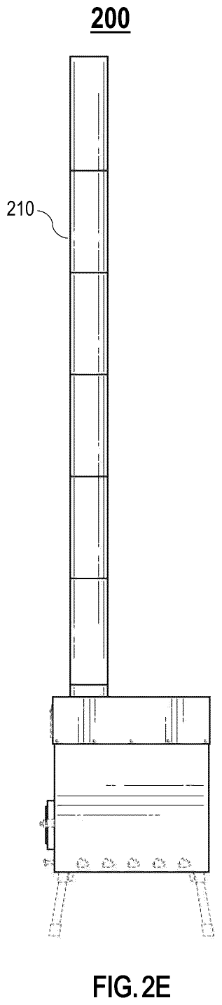

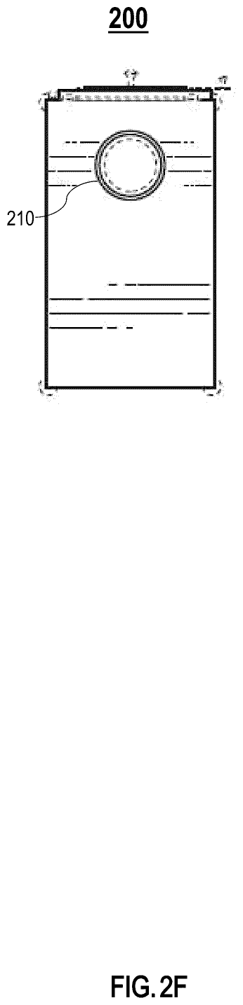

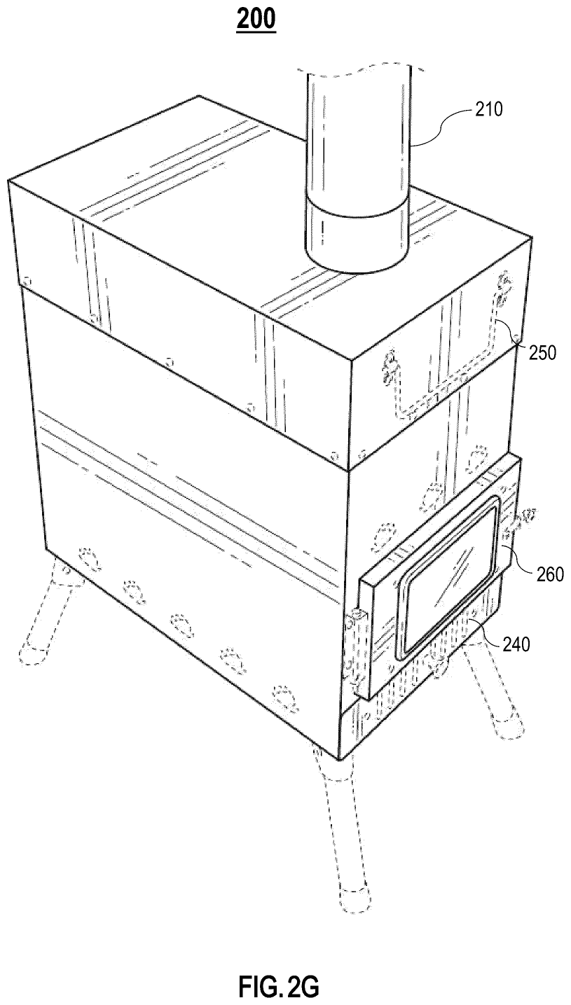

FIG. 2A illustrates a front perspective view of a sauna stove 200, in one or more embodiments. FIG. 2B illustrates a front view of the sauna stove 200, in one or more embodiments. FIG. 2C illustrates a left side view of the sauna stove 200, in one or more embodiments. FIG. 2D illustrates a rear view of the sauna stove 200, in one or more embodiments. FIG. 2E illustrates a right side view of the sauna stove 200, in one or more embodiments. FIG. 2F illustrates a top view of the sauna stove 200, in one or more embodiments. FIG. 2G illustrates a front perspective close-up view of the sauna stove 200, in one or more embodiments. In one embodiment, the sauna stove 200 is stainless steel.

In one embodiment, the sauna stove 200 comprises a wood-fired sauna stove. In another embodiment, the sauna stove 200 comprises an electric sauna stove. If the sauna stove 200 is electric, the top of the tent 100 need not have hole openings (and fabric chimney hole covers 155 for covering the hole openings are not needed).

In one embodiment, the sauna stove 200 comprises a slidable air control vent 240 for intake of air.

In one embodiment, the sauna stove 200 comprises a carrying handle 250 to facilitate carrying of the sauna stove 200.

In one embodiment, the sauna stove 200 comprises a stove door 260 that can be latched shut while a fire is burning inside the sauna stove 200.

FIG. 3 illustrates a sequence of user steps required to assemble the sauna tent 100 and install the sauna stove 200 inside the sauna tent 100, in one or more embodiments. In a first step (“Step 1”), a user removes the tent frame 110 including the fabric awning 120 from a carry bag 350, and begins erecting the sauna tent 100 on a suitable, well-ventilated area outside by pulling on an endpoint 131 (FIG. 1A) of any tent sidewall 130. In a second step (“Step 2”), the user pulls forcefully until the tent sidewall 130 pops out into place, and repeats Steps 1 and 2 for each remaining tent sidewall 130 until all the tent sidewalls 130 pop out into place.

In a third step (“Step 3”), the user pushes up on an endpoint 131 of the roof top 140 from inside the sauna tent 100 until the roof top 140 pops out into place.

In a fourth step (“Step 4”), the user should ensure that the sauna tent 100 is standing in an upright position and that each side of the sauna tent 100 is at least two (2) feet away from any structure, debris, brush, low-hanging branches, etc.

In a fifth step (“Step 5”), the user should place weights (e.g., potted plants, rocks, bricks, cinder blocks, etc.) and/or material (e.g., snow, sand, etc.) on top of the exterior/outer tent skirts 160 to weigh it down and in turn seal the perimeter of the sauna tent 100 and secure the sauna tent 100 to the surface, thereby preventing the sauna tent 100 from blowing over and further preventing wind and wind-driven elements (e.g., wind-driven sand, wind-driven snow) from entering inside the sauna tent 100. Stakes and ropes may also be used to further secure the sauna tent 100 to the ground.

In a sixth step (“Step 6”), the user places the roof top cover 300 on top of the roof top 140.

In a seventh step (“Step 7”), the user anchors corners of the roof top cover 300 to loops on the tent sidewalls 130 using carabiners and straps.

In an eighth step (“Step 8”), the user places the sauna stove 200—with its chimney pipe 210 disconnected—inside the sauna tent 100 (e.g., by carrying the sauna stove 200 via the carrying handle 250). The user must position the sauna stove 200 such that it faces the tent flap 190 and is directly below a hole opening 150 on the top of the tent (e.g., a pair of aligned hole openings on the roof top 140 and the roof top cover 300).

In a ninth step (“Step 9”), the user places a fabric chimney hole cover 155 with its metal-lined opening 156 on the top of the sauna tent 100.

In a tenth step (“Step 10”), the user connects the chimney pipe 210 to the sauna stove 200, and passes the chimney pipe 210 through the metal-lined opening 156.

In an eleventh step (“Step 11”), the user ensures the fabric chimney hole cover 155 is secured to the top of the sauna tent 100 by pressing it down firmly so that velcro 157 on the back of the cover 155 is secured.

FIG. 4 illustrates an insulated enclosure 105 created inside the sauna tent 100, in one or more embodiments. In one embodiment, the inside of the sauna tent 100 can accommodate one or more sauna stoves 200. For example, as shown in FIG. 4, in one embodiment, the shape and size of the sauna tent 100 allows for only one sauna stove 200 to be positioned inside the sauna tent 100. As another example, in one embodiment, the shape and size of the sauna tent 100 allows for two or more sauna stoves 200 to be positioned inside the sauna tent 100. A bench or other type of seating may also be placed inside the sauna tent 100, as shown in FIG. 4.

In one embodiment, the inside enclosure 105 may be divided into multiple chambers. For example, the inside enclosure may be divided into a first chamber for bathing and a second chamber operating as a waiting room, wherein a sauna stove 200 is positioned inside the first chamber for bathing.

In one embodiment, flame-retardant/flame-resistant material may be placed on the interior of one or more tent sidewalls 130 that are within proximity of a sauna stove 200 to prevent damage to these tent sidewalls 130. In another embodiment, a metal heat shield may be placed around the sauna stove 200 instead to prevent damage to these tent sidewalls 130.

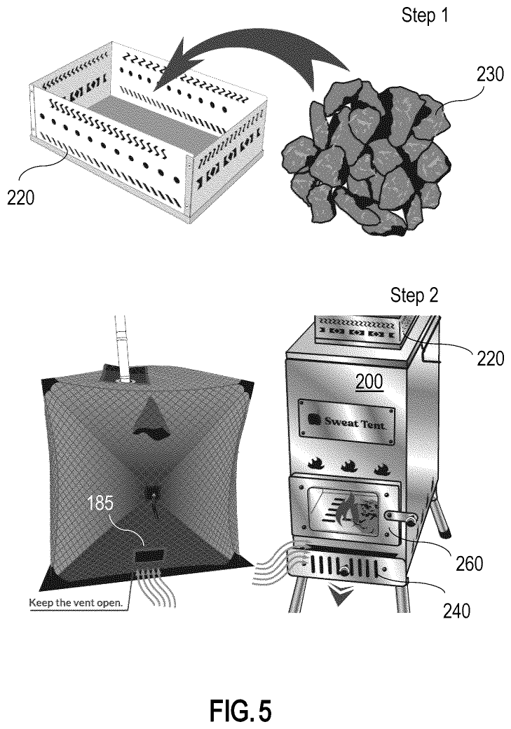

FIG. 5 illustrates a sequence of user steps required to fire up the sauna stove 200 when inside the sauna tent 100, in one or more embodiments. In a first step (“Step 1”), a user places sauna rocks 230 into a basket 220, and positions the basket 220 on top of the sauna stove 200.

In a second step (“Step 2”), the user slides each fresh air intake vent 185 to a fully open position to ensure that fresh air is coming inside of the tent 200, and also slides the air control vent 240 on the sauna stove 200 to a fully open position so that a maximum amount of air can flow into the sauna stove 200. The user then fires/heats up the sauna stove 200 (e.g., lighting a fire in the sauna stove 200 if it is wood-fired using wood), and latches the stove door 260 shut while a fire is burning inside the sauna stove 200. When sauna stove 200 is fired/heated up, the user pours water over the sauna rocks 230 to create hot steam that heats up the temperature inside of the sauna tent 100. The inside of the sauna tent 100 can reach temperatures of about 176° F. to about 212° F. within about thirty (30) minutes of the sauna stove 200 firing/heating up, and a maximum temperature of 220° F. The fabric awning 120 allows the temperature inside of the sauna tent 100 to be maintained in any environment.

When the inside of the sauna tent 100 reaches a temperature suitable for therapeutic use (e.g., about 176° F. to about 212° F.), the user can slide each fresh air intake vent 185 to a halfway open position slow the burn rate of the sauna stove 200 and further maintain the temperature inside of the sauna tent 100.

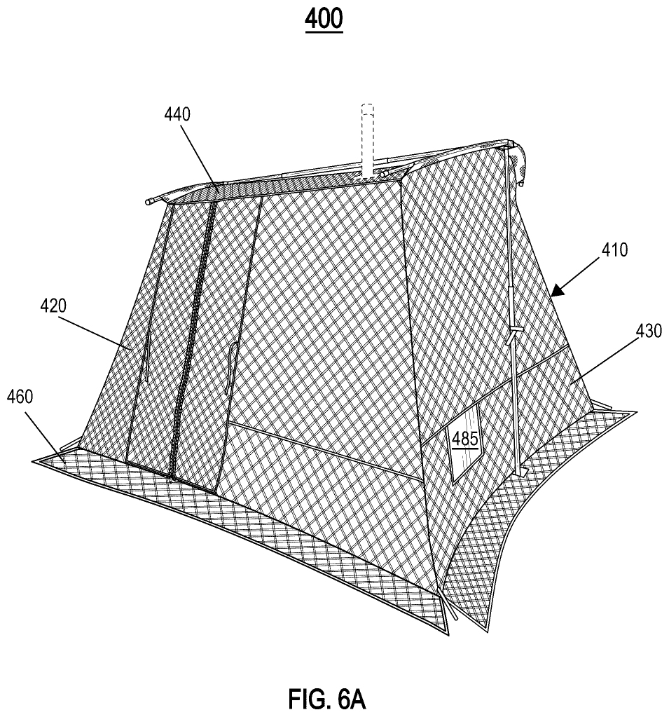

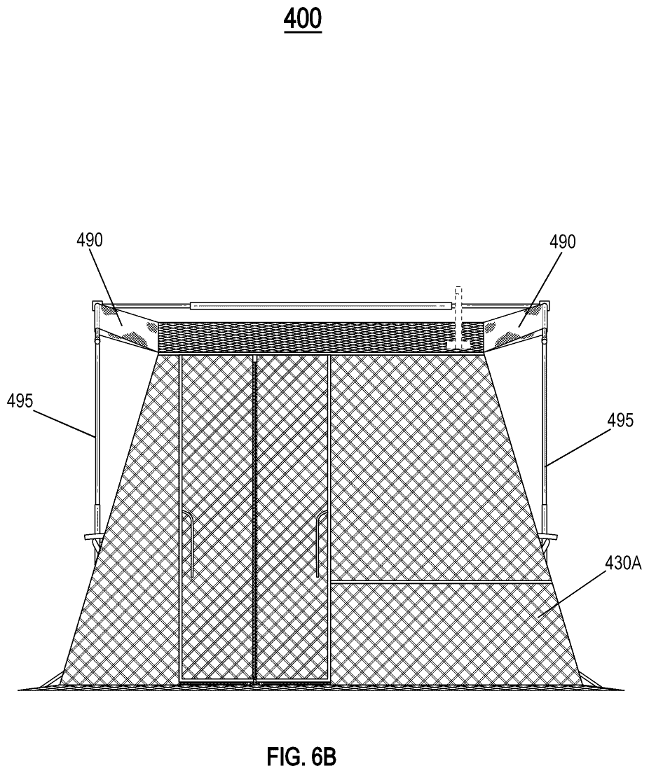

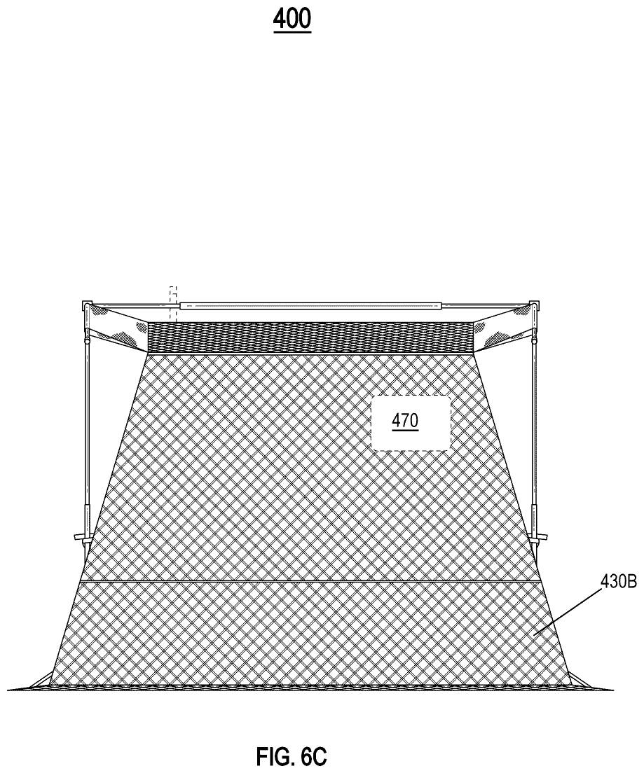

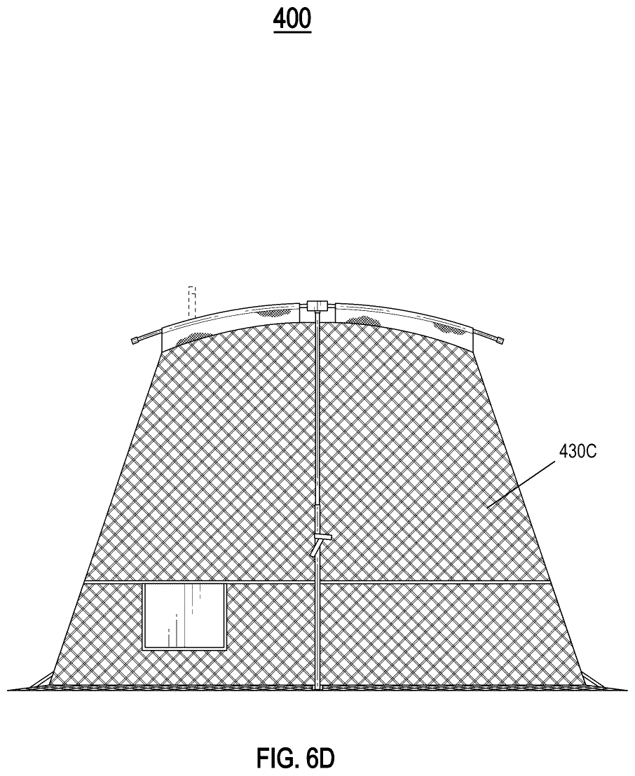

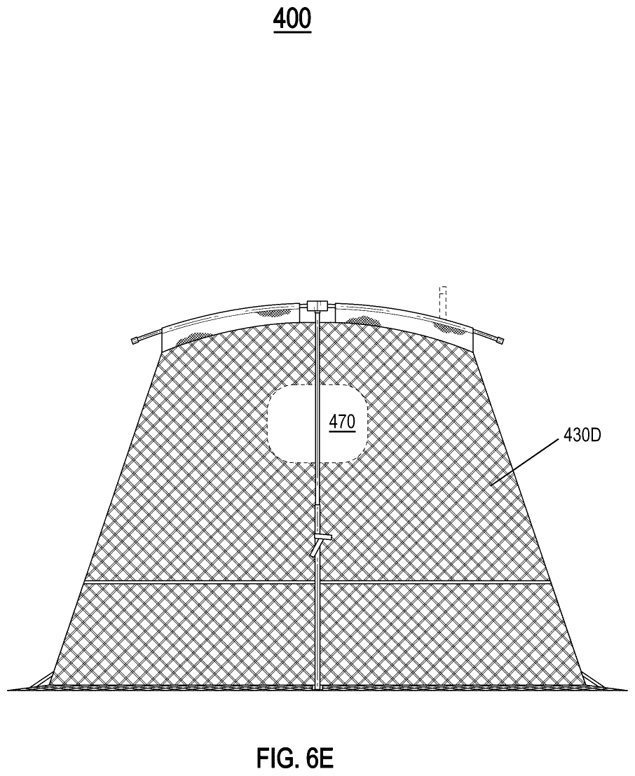

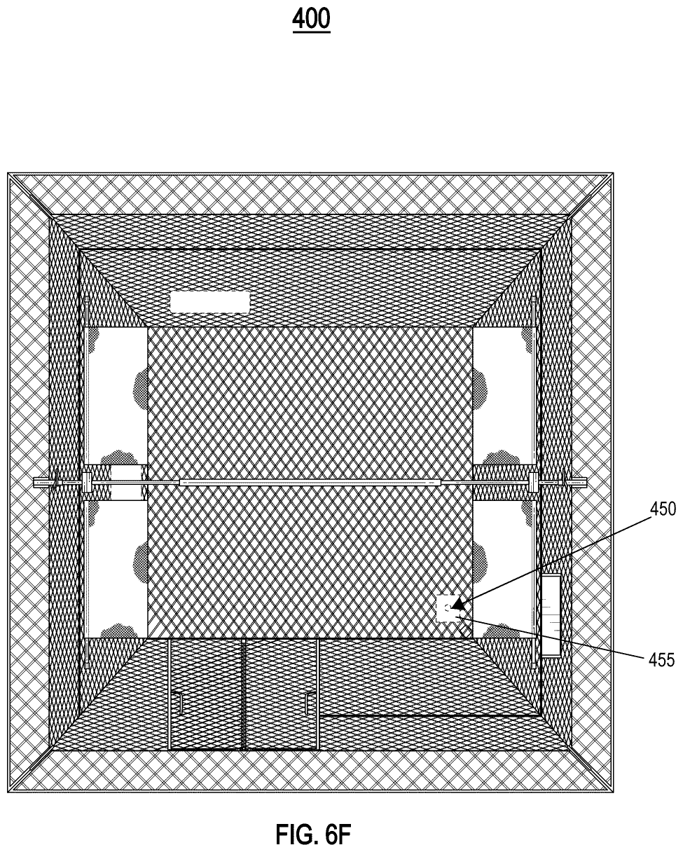

FIGS. 6A-6F illustrate another example of an insulated sauna tent 400, in one or more embodiments. Specifically, FIG. 6A illustrates a perspective view of another insulated sauna tent 400, in one or more embodiments. FIG. 6B illustrates a front view of the insulated sauna tent in FIG. 6A, in one or more embodiments. FIG. 6C illustrates a rear view of the insulated sauna tent in FIG. 6A, in one or more embodiments. FIG. 6D illustrates a right side view of the insulated sauna tent in FIG. 6A, in one or more embodiments. FIG. 6E illustrates a left side view of the insulated sauna tent in FIG. 6A, in one or more embodiments. FIG. 6F illustrates a top view of the insulated sauna tent in FIG. 6A, in one or more embodiments.

The sauna tent 400 comprises a collapsible tent frame 410 including a plurality of framing rods (e.g., framing rods 111 in FIG. 4). In one embodiment, the tent frame 410 (and in turn the sauna tent 400) is assembled to stand in an upright position by fitting/locking together the framing rods into place using attachment mechanisms (e.g., attachment mechanisms 115 in FIG. 4). The tent 400 is assembled in a pop-up fashion. The tent frame 410 (and in turn the sauna tent 400) is disassembled and collapsed by disconnecting/unlocking and collapsing the framing rods.

The sauna tent 400 comprises a continuous fabric awning 420 attached to the tent frame 410. In one embodiment, the disassembled and collapsed tent frame 410 including the fabric awning 420 are transportable in a carry bag (e.g., carry bag 350 in FIG. 3).

In one embodiment, the fabric awning 420 is multi-layered (i.e., two layers or more), weatherproof, and insulated. For example, in one embodiment, the fabric awning 420 comprises a durable triple-layered quilted fabric consisting of a first layer of water-resistant/weather-resistant fabric, a second layer of synthetic heating/insulation material, and a third layer of water-resistant/weather-resistant fabric. The first layer of water-resistant/weather-resistant fabric and the third layer of water-resistant/weather-resistant fabric form the outermost layer and innermost layer of the fabric awning 420, respectively. The second layer of synthetic heating/insulation material is positioned in-between both layers of water-resistant/weather-resistant fabric. In one embodiment, both layers of water-resistant fabric are composed of polyester or nylon (e.g., Oxford or Taffeta fabrics, such as Oxford 210D nylon) with a polyurethane coating applied to repel moisture. In one embodiment, the layer of synthetic heating/insulation material is composed of any material suitable for heating/insulation and of any density.

In one embodiment, the fabric awning 420 is thermal-sealed (i.e., the fabric stitching of the fabric awning 420 comprises thermal seams), such that no holes are created in the fabric awning 420, thereby preventing cold air, moisture, and other elements of the environment from entering the sauna tent 400. In another embodiment, the fabric stitching of the fabric awning 420 comprises traditional sewing seams.

The tent frame 410 and the fabric awning 420 are designed/shaped to provide a plurality of tent sidewalls (i.e., tent side panels) 430 and a roof top 440 that together create an insulated enclosure inside the sauna tent 400. For example, as shown in FIGS. 6A-6E, in one embodiment, the plurality of tent sidewalls 430 include at least four tent sidewalls 430, i.e., a first tent sidewall 430A (FIG. 6B), a second tent sidewall 430B (FIG. 6C), a third tent sidewall 430C (FIG. 6D), and a fourth tent sidewall 430D (FIG. 6E). One or more sauna stoves 200 (FIG. 2A) may be positioned inside the sauna tent 400.

In one embodiment, the roof top 440 includes one or more hole openings 450 (FIG. 6F), wherein each hole opening 450 corresponds to a sauna stove 200 positioned directly below the hole opening 450 and inside the sauna tent 400. Each hole opening 450 has a corresponding fabric chimney hole cover 455 including a metal-lined opening (e.g., metal-lined opening 156 in FIG. 1F) designed/shaped to sit over the hole opening 450 and receive a chimney pipe 210 (FIG. 2A) of a sauna stove 200, thereby allowing the chimney pipe 210 to pass through from inside the sauna tent 400 to outside the sauna tent 400.

Together, the fabric awning 420 and the sauna stove 200 enhance the insulating properties of the sauna tent 400, enabling the inside of the sauna tent 400 to reach temperatures of about 176° F. to about 212° F. within about thirty (30) minutes of firing/heating up the sauna stove 200, and a maximum temperature of 220° F. The fabric awning 420 allows the temperature inside of the sauna tent 400 to be maintained in any environment. This combination of materials—the tent frame 410, the fabric awning 420, and the sauna stove 200—provide a compact, lightweight, portable, and cost-effective sauna capable of reaching and maintaining a high heat output. Unlike traditional saunas such as Finnish-style saunas, the sauna tent 400 provides a user with an accessible and affordable therapeutic sauna experience.

In one embodiment, the sauna tent 400 has a variety of sizes. In one embodiment, the sauna tent 400 has a variety of shapes such as, but not limited to, pyramids, squares, rectangles, hexagons, octagons, etc.

In one embodiment, the sauna tent 400 does not include any floor/flooring. The sauna tent 400 can be assembled to stand upright on any substantially flat surface, such as the ground, a floor, etc. For example, the sauna tent 400 may be assembled on a suitable, well-ventilated area outside on concrete, tile, dirt, grass, turf, ice, or unvarnished wood surface (e.g., as shown in FIG. 3). In another embodiment, the sauna tent 400 comprises an optional floor/flooring.

In one embodiment, the fabric awning 420 provides a plurality of tent skirts 460 attached to bottom edges of the tent sidewalls 430, such that each tent sidewall 430 has a corresponding exterior/outer tent skirt 460 (i.e., located outside of the tent 400) and a corresponding interior/inner tent skirt (i.e., located inside the sauna tent 400). The tent skirts 460 are designed/shaped to lay flat on top of a surface that the sauna tent 400 is assembled on. Weights (e.g., potted plants, rocks, bricks, cinder blocks, etc.) and/or material (e.g., snow, sand, etc.) may be placed on top of the exterior/outer tent skirts 460 to weigh it down and in turn seal the perimeter of the sauna tent 400 and secure the sauna tent 400 to the surface, thereby preventing the sauna tent 400 from blowing over and further preventing wind and wind-driven elements (e.g., wind-driven sand, wind-driven snow) from entering inside the sauna tent 400.

In one embodiment, a tent sidewall 430 and/or the roof top 440 may include one or more windows 470 (FIGS. 6C and 6E). In one embodiment, each window 470 is composed of a high-temperature performance material such as, but not limited to, thermoplastic polyurethane (TPU), etc. Each window 470 allows ambient light to enter the sauna tent 400 and/or provides a user inside the sauna tent 400 to view outside the sauna tent 400 (e.g., provide a 480° view). The windows 470 of the sauna tent 400 may have a variety of shapes and sizes.

In one embodiment, a tent sidewall 430 and/or the roof top 440 may include one or more temperature control vents (e.g., temperature control vent 180 in FIG. 1D) to help circulate air inside the sauna tent 400 and keep the temperature inside of the sauna tent 400 regulated. In one embodiment, a tent sidewall 430 and/or the roof top 440 may include one or more fresh air intake vents 485 for intake of fresh air into the sauna tent 400. Each fresh air intake vent 485 is slidable between a fully open position, a halfway open position, and a fully closed position.

In one embodiment, the sauna tent 400 comprises one or more collapsible roof top flaps 490 (FIG. 6B) located along one or more edges of the roof top 440 to provide shade. Each roof top flap 490 has a corresponding support rod 495 attached to a tent sidewall 430; via the support rod 495, the roof top flap 490 can be positioned in an upright position (as shown in FIG. 6B) or collapsed.

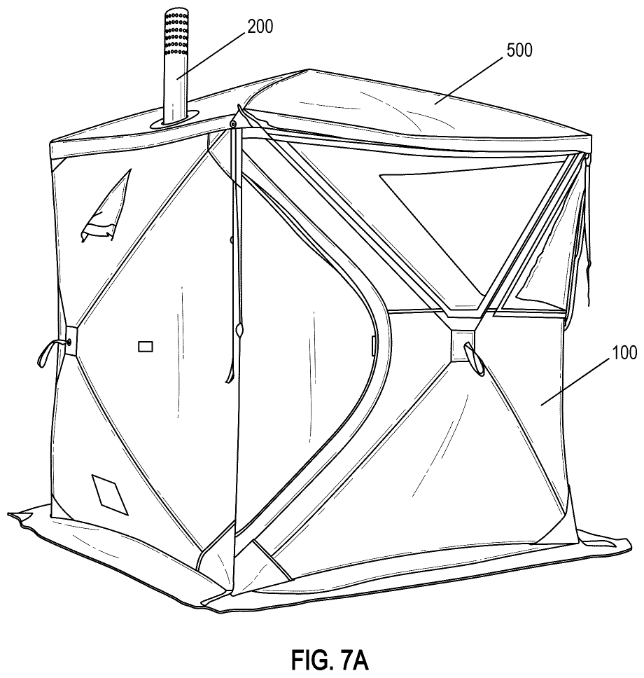

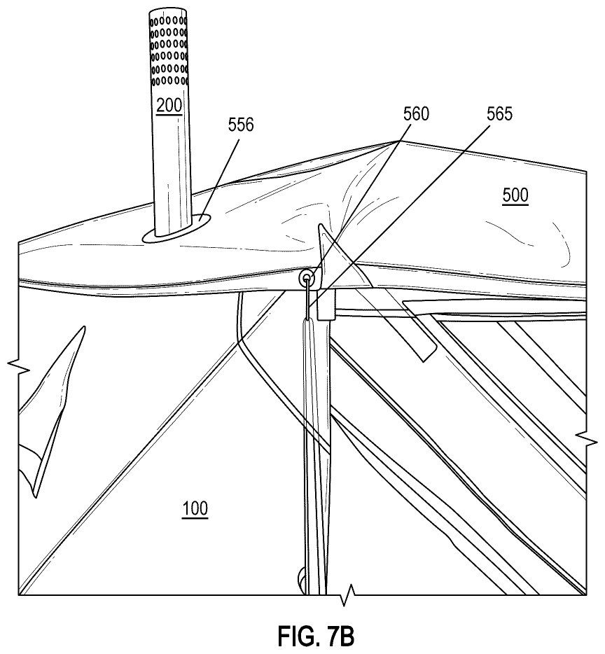

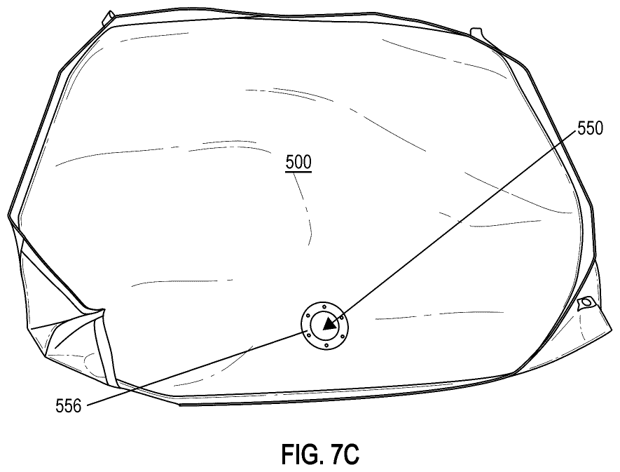

FIGS. 7A-7C illustrate another example of a roof top cover 500, in one or more embodiments. Specifically, FIG. 7A illustrates a perspective view of the insulated sauna tent 100 with the roof top cover 500 secured to the roof top of the sauna tent 100, in one or more embodiments. FIG. 7B illustrates a close-up view of the roof top cover 500 secured to the roof top of the sauna tent 100, in one or more embodiments. FIG. 7C illustrates the roof top cover 500 on its own, in one or more embodiments.

The roof top cover 500 includes one or more hole openings 550 (FIG. 7C), wherein each hole opening 550 corresponds to a sauna stove 200 positioned directly below the hole opening 550 and inside the sauna tent 100. Each hole opening 550 has a corresponding metal-lined opening 556 (e.g., a metal circular ring) (FIGS. 7B and 7C) designed/shaped to sit over the hole opening 550 and receive a chimney pipe 210 of a sauna stove 200, thereby allowing the chimney pipe 210 to pass through from inside the sauna tent 100 to outside the sauna tent 100. The roof top cover 500 protects the sauna tent 100 from damage by preventing runaway fire sparks emanating from a chimney pipe 210 of a sauna stove 200 inside the sauna tent 100 from burning holes in the roof top of the sauna tent 100. The roof top cover 500 also further insulates the sauna tent 100. In one embodiment, the roof top cover 500 is made out of flame-retardant/flame-resistant and waterproof/weatherproof materials such as, but not limited to, fiberglass.

In one embodiment, the roof top cover 500 includes one or more metal-lined holes 560 (FIG. 7B) through which one or more cable or support ties 565 (FIG. 7B) may be threaded through to securely mount the cover 500 to the roof top of the sauna tent 100.

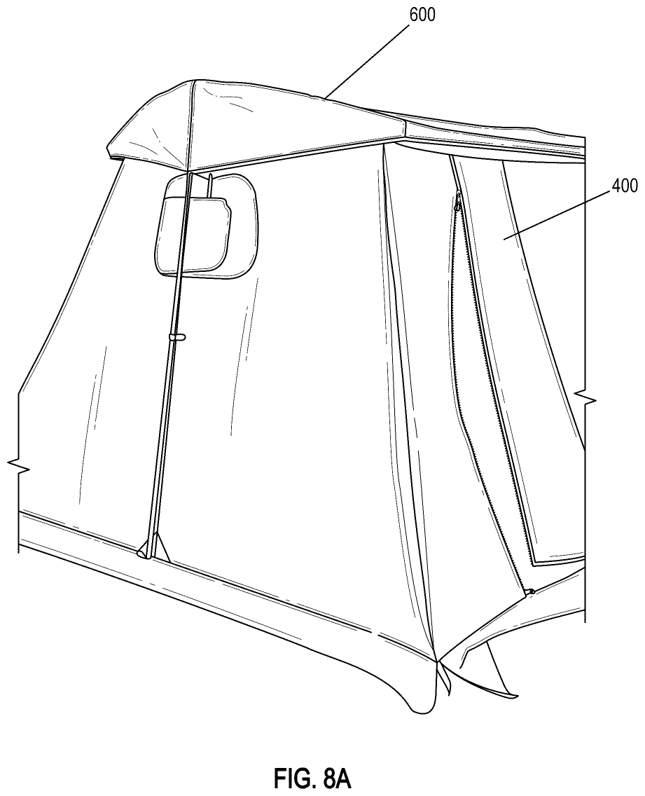

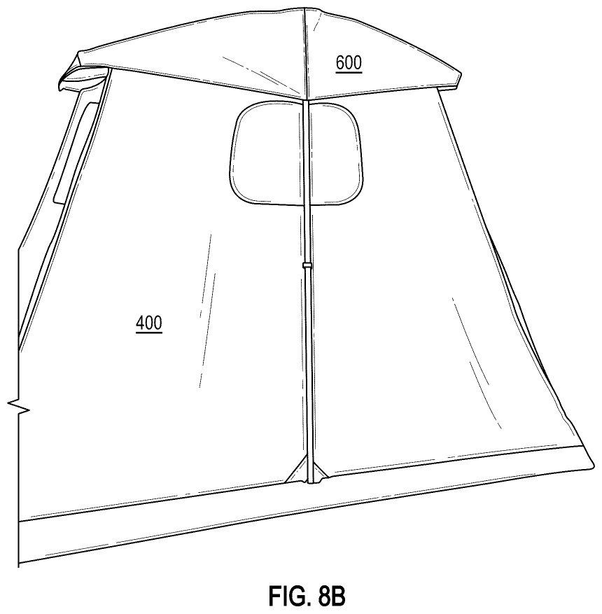

FIGS. 8A-8B illustrate yet another example of a roof top cover 600, in one or more embodiments. Specifically, FIG. 8A illustrates a perspective view of the insulated sauna tent 400 with the roof top cover 600 secured to the roof top of the sauna tent 400, in one or more embodiments. FIG. 8B illustrates another perspective view of the insulated sauna tent 400 with the roof top cover 600 secured to the roof top of the sauna tent 400, in one or more embodiments Similar to the roof top cover 500, the roof top cover 600 includes one or more hole openings (e.g., hole opening 550 in FIG. 7C), wherein each hole opening corresponds to a sauna stove 200 positioned directly below the hole opening and inside the sauna tent 400. Each hole opening has a corresponding metal-lined opening (e.g., metal-lined opening 556 in FIGS. 7B and 7C) designed/shaped to sit over the hole opening and receive a chimney pipe 210 of a sauna stove 200, thereby allowing the chimney pipe 210 to pass through from inside the sauna tent 400 to outside the sauna tent 400. The roof top cover 600 protects the sauna tent 400 from damage by preventing runaway fire sparks emanating from a chimney pipe 210 of a sauna stove 200 inside the sauna tent 400 from burning holes in the roof top of the sauna tent 400. The roof top cover 600 also further insulates the sauna tent 400. In one embodiment, the roof top cover 600 is made out of flame-retardant/flame-resistant and waterproof/weatherproof materials such as, but not limited to, fiberglass.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the embodiments has been presented for purposes of illustration and description, but is not intended to be exhaustive or limited to the embodiments in the form disclosed. Many modifications and variations will be apparent to those of ordinary skill in the art without departing from the scope and spirit of the invention.

Though the embodiments have been described with reference to certain versions thereof; however, other versions are possible. Therefore, the spirit and scope of the appended claims should not be limited to the description of the preferred versions contained herein.

What is claimed is:

1. A portable and insulated sauna tent comprising:
a collapsible tent frame including a plurality of connectable framing rods; and
a continuous fabric awning that is multi-layered, weatherproof, and insulated, wherein the fabric awning is attached to and covers an entirety of the tent frame, and the tent frame and the fabric awning together form an insulated enclosure with a plurality of tent sidewalls and a roof top when the tent frame is assembled into an upright position by connecting the framing rods;
wherein the insulated enclosure reaches and maintains a temperature suitable for therapeutic use when a portable sauna stove is placed inside the insulated enclosure and heated up.

2. The sauna tent of claim 1, further comprising:
the portable sauna stove.

3. The sauna tent of claim 1, wherein the temperature suitable for therapeutic use is in the range of 176° F. to 212° F.

4. The sauna tent of claim 1, wherein each framing rod is made of a metal alloy or a polymer.

5. The sauna tent of claim 1, wherein the fabric awning comprises at least an outermost layer of water-resistant fabric, an innermost layer of water-resistant fabric, and a layer of insulation material in between the outermost layer and the innermost layer.

6. The sauna tent of claim 5, wherein the outermost layer and the innermost layer are made of either an Oxford fabric or a Taffeta fabric with a polyurethane coating applied.

7. The sauna tent of claim 1, wherein the fabric awning is quilted and thermal-sealed.

8. The sauna tent of claim 1, further comprising:
a removable roof top cover that is flame-resistant, weatherproof, and shaped for placement on top of the roof top to further insulate the insulated enclosure.

9. The sauna tent of claim 1, wherein the roof top cover is made out of fiberglass.

10. The sauna tent of claim 1, further comprising:
a hole opening on top of the roof top, wherein the hole opening is shaped to receive a chimney pipe of the portable sauna stove.

11. The sauna tent of claim 1, wherein the portable sauna stove is either electric or wood-fired.

12. A portable and insulated sauna system comprising:
a collapsible tent frame including a plurality of connectable framing rods;
a continuous fabric awning that is multi-layered, weatherproof, and insulated, wherein the fabric awning is attached to and covers an entirety of the tent frame, and the tent frame and the fabric awning together form an insulated enclosure with a plurality of tent sidewalls and a roof top when the tent frame is assembled into an upright position by connecting the framing rods; and
a portable sauna stove;
wherein the insulated enclosure reaches and maintains a temperature suitable for therapeutic use when the portable sauna stove is placed inside the insulated enclosure and heated up.

13. The sauna system of claim 12, wherein the temperature suitable for therapeutic use is in the range of 176° F. to 212° F.

14. The sauna system of claim 12, wherein each framing rod is made of a metal alloy or a polymer.

15. The sauna system of claim 12, wherein the fabric awning comprises at least an outermost layer of water-resistant fabric, an innermost layer of water-resistant fabric, and a layer of insulation material in between the outermost layer and the innermost layer.

16. The sauna system of claim 15, wherein the outermost layer and the innermost layer are made of either an Oxford fabric or a Taffeta fabric with a polyurethane coating applied.

17. The sauna system of claim 12, wherein the fabric awning is quilted and thermal-sealed.

18. The sauna system of claim 12, further comprising:
a removable roof top cover that is flame-resistant, weatherproof, and shaped for placement on top of the roof top to further insulate the insulated enclosure.

19. The sauna system of claim 12, wherein the roof top cover is made out of fiberglass.

20. The sauna system of claim 12, further comprising:
a hole opening on top of the roof top, wherein the hole opening is shaped to receive a chimney pipe of the portable sauna stove.
